(19) United States
(12) Patent Application Publication
(10) Pub. No.: US 2026/0105711 A1
(43) Pub. Date: Apr. 16, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KANJI SUZUKI, Kanagawa (JP)

(21) Appl. No.: 19/339,823

(22) Filed: Sep. 25, 2025

(30) Foreign Application Priority Data
Oct. 15, 2024 (JP) 2024-179779

(51) Int. Cl. G06T 19/20; G06T 15/04

(52) U.S. Cl. CPC G06T 19/20; G06T 15/04; G06T 2219/2021

(57) ABSTRACT

An image processing apparatus includes at least one memory storing instructions; and at least one processor executing the stored instructions causing the image processing apparatus to acquire three-dimensional data having shape information and texture information, generate an additional shape to be added to a shape corresponding to the acquired shape information, and associate the shape information with the texture information. A resolution of vertices configuring the shape information is smaller than a resolution of the texture information. Executing the stored instructions by the processor further causes the image processing apparatus to associate the acquired texture information with the additional shape.

### BACKGROUND

### Field of the Technology

The present disclosure relates to an image processing technology concerning three-dimensional data.

### Description of the Related Art

An imaging apparatus such as a 3D camera is capable of acquiring distance distribution information. A three-dimensional surface model can be generated by performing perspective projection conversion on distance distribution information to acquire a point cloud, and then further generating polygon data by assigning phase information between vertices of the point cloud. By acquiring an image (color distribution information) simultaneously with distance distribution information and generating three-dimensional data that includes texture information, a user can enjoy viewing the image from an arbitrary virtual viewpoint.

Meanwhile, in three-dimensional data that has been generated based on distance distribution information obtained from a limited number of viewpoints, there may be regions that actually exist on the subject but cannot be reconstructed in the three-dimensional data. For example, a case is assumed in which three-dimensional data of a human body is generated in which a hand is positioned in front of the human body. In such a case, the information regarding the portion of the human body that is obstructed from the front by the hand becomes missing (occlusion). In a case in which rendering is performed from a viewpoint other than the front of the human body with respect to such three-dimensional data, the missing portion of the occluded region may become visible, possibly resulting in a sense of unnaturalness when viewed.

Varun Jampani et al., “SLIDE: Single Image 3D Photography with Soft Layering and Depth-aware Inpainting”, Proceedings of the IEEE International Conference on Computer Vision, 2021, discloses an inpainting technique for reconstructing missing or deteriorated image data. With respect to a missing portion that occurs in a part of the background due to occlusion by a foreground, inpainting is performed in which the shape and color information of the missing portion are generated by deep learning, based on image information for the background that is adjacent to the missing portion of the background.

In general, inpainting processing of image data requires a high computational cost. In particular, the impact becomes significant in a case in which high-resolution image information is used. In the prior art disclosed in Varun Jampani et al., “SLIDE: Single Image 3D Photography with Soft Layering and Depth-aware Inpainting”, Proceedings of the IEEE International Conference on Computer Vision, 2021, the time required for inference may become excessively long in a case in which the resolution of the input image is high.

### SUMMARY

The present disclosure is directed to provide an image processing technology capable of further reducing computational cost while suppressing a sense of unnaturalness when viewing three-dimensional data that includes occlusion.

An image processing apparatus according to an aspect of the present disclosure includes at least one memory storing instructions; and at least one processor executing the stored instructions causing the image processing apparatus to: acquire three-dimensional data including shape information and texture information; generate an additional shape to be added to a shape corresponding to the acquired shape information; and associate the shape information with the texture information. A resolution of vertices configuring the shape information is lower than a resolution of the texture information, and executing the stored instructions by the processor further causes the image processing apparatus to associate the acquired texture information with the additional shape.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram of an imaging apparatus according to an embodiment.

FIG. 2 is a flowchart that explains image processing according to the embodiment.

FIG. 3 is an explanatory diagram of an invisible region and a region having a depth difference.

FIG. 4 is a schematic diagram concerning an additional shape.

FIG. 5 is an explanatory diagram of a surface map.

FIG. 6A and FIG. 6B are explanatory diagrams of correspondence between a surface and a texture.

FIG. 7 is a diagram illustrating a positional relation between an imaging unit and subjects.

FIG. 8 is a diagram illustrating a correspondence relation between a distance map and a texture.

FIGS. 9A, 9B, and FIG. 9C are schematic diagrams showing a surface map and a texture coordinate system according to a comparative example, a second comparative example, and the embodiment.

FIG. 10 is a flowchart that explains an association process in the embodiment.

FIG. 11 is a schematic diagram concerning an additional shape in a first modified example.

FIG. 12A and FIG. 12B are schematic diagrams that explain differences between the comparative example and the first modified example.

FIG. 13 is a diagram illustrating a reference region on texture coordinates in a third modified example.

FIG. 14 is a flowchart that explains image processing in a fourth modified example.

FIG. 15 is a diagram illustrating a correction region on texture coordinates in the fourth modified example.

FIG. 16 is a diagram illustrating a reference region on texture coordinates in a fifth modified example.

FIGS. 17A, 17B, and FIG. 17C are schematic diagrams illustrating a surface map and a texture coordinate system according to the comparative example, the embodiment, and a sixth modified example.

FIG. 18 is an explanatory view of a correspondence relation between a distance map and a texture according to a seventh modified example.

FIG. 19A and FIG. 19B are schematic diagrams illustrating a surface map and a texture coordinate system according to the embodiment and the seventh modified example.

FIG. 20 is an explanatory view of a correspondence relation between a distance map and a texture according to an eighth modified example.

FIG. 21A and FIG. 21B are schematic diagrams illustrating a surface map and a texture coordinate system according to the embodiment and the eighth modified example.

FIG. 22 is a schematic diagram illustrating a surface map and a texture coordinate system according to the comparative example.

FIG. 23A and FIG. 23B are schematic diagrams illustrating a surface map according to a ninth modified example.

FIG. 24 is a diagram illustrating a positional relation between an imaging unit and a subject in a tenth modified example.

FIG. 25A and FIG. 25B are schematic diagrams illustrating a surface map and a texture coordinate system according to the embodiment and the tenth modified example.

### DESCRIPTION OF THE EMBODIMENTS

Embodiments of the present disclosure will be explained in detail below with reference to the accompanying drawings. Definitions of terms used and premise conditions will be explained regarding the image processing apparatus and image processing method according to the present disclosure.
“Three-dimensional data” refers to data including three-dimensional shape information to be processed and includes a point cloud and a three-dimensional surface model. The three-dimensional data may include color information in addition to shape information.
“Shape” refers to a surface that is formed by vertices and the connection relationships between the vertices.
“Polygon” refers to a surface that is formed by connecting a plurality of vertices. A “surface” is a set of polygons.
“Texture” refers to color distribution information or an image that is allocated onto the shape of the three-dimensional data.
“Texture coordinates” refer to relative coordinates within a texture image, and are synonymous with, for example, UV coordinates.

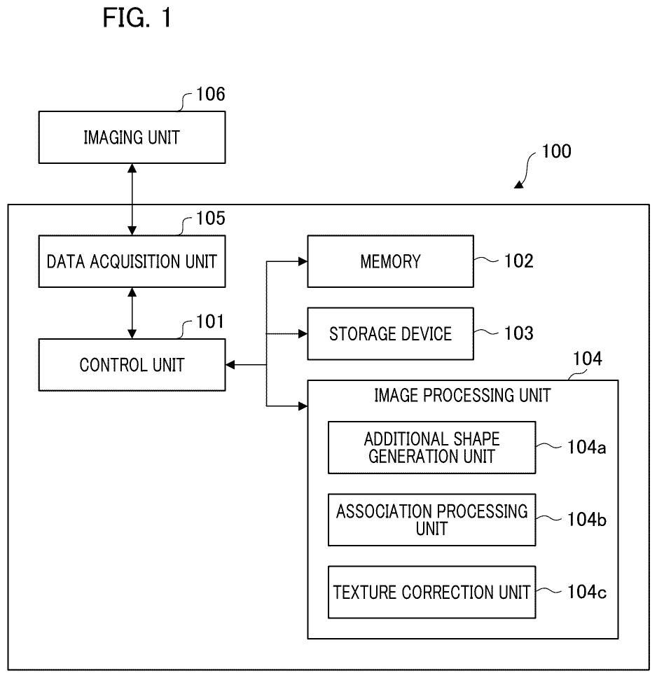

FIG. 1 is a block diagram illustrating an outline of an imaging apparatus according to the present embodiment. An example of a configuration of an imaging apparatus to which an image processing apparatus 100 is applied is shown. The imaging apparatus includes the image processing apparatus 100 and an imaging unit 106.

The imaging unit 106 captures an image of a subject and outputs the captured imaging information to the image processing apparatus 100. For example, the imaging unit 106 has a configuration of a stereo camera or a Time-of-Flight type camera, or includes a pupil-division type image sensor employing phase difference detection on the imaging plane. The imaging unit 106 only needs to acquire information necessary for generating three-dimensional data and is not limited to a specific configuration.

The image processing apparatus 100 includes a control unit 101, a memory 102, a storage device 103, an image processing unit 104, and a data acquisition unit 105. The control unit 101 includes a central arithmetic processing unit (CPU) and the like and controls each block element that is included in the image processing apparatus 100. For example, the control unit 101 performs processing for acquiring imaging information from the imaging unit 106 via the data acquisition unit 105. The control unit 101 outputs the acquired imaging information to the image processing unit 104 and controls storage of the image processing results in the storage device 103.

The memory 102 is used for temporarily storing information, and a storage device such as volatile memory is used. The storage device 103 is a device capable of storing information permanently, and for example, a hard disk drive (HDD) is used. Imaging information acquired by the imaging unit 106 and parameters used by the image processing unit 104 are stored in the storage device 103.

The image processing unit 104 includes an additional shape generation unit 104a, an association processing unit 104b, and a texture correction unit 104c. Details of each unit will be described below. The image processing unit 104 performs predetermined image processing on the information acquired by the imaging unit 106 according to the image processing method to be described below. The image processing unit 104 may be configured as an integrated circuit or may be a functional module realized by software.

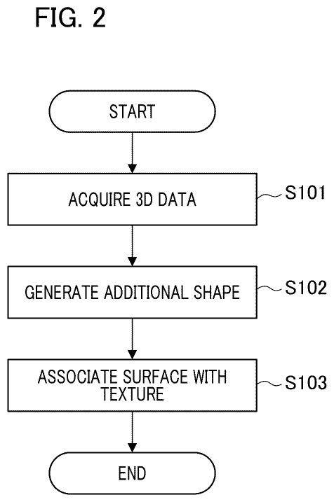

Processing in the present embodiment will be explained with reference to FIG. 2. FIG. 2 is a flowchart that explains the processing performed by the image processing unit 104 on three-dimensional data relating to a subject. Note that the process of generating three-dimensional data related to the subject based on information acquired by the imaging unit 106 is well-known, and therefore, a detailed explanation thereof will be omitted.

Step S101 corresponds to a process in which the data acquisition unit 105 acquires three-dimensional data. During the process of acquiring three-dimensional data, the processing for acquiring three-dimensional data including shape information and texture information is performed. This process serves to prepare the three-dimensional data so that it can be processed in the subsequent processes. For example, import of already generated three-dimensional data, expansion processing onto the memory 102, and the like may be performed.

In the present embodiment, it is a premise that the resolution of the vertices configuring the surface is lower than the resolution of the texture. In other words, the total number of vertices forming the surface is assumed to be smaller than the number of pixels in the texture. Hereinafter, the texture at the completion of step S101 is referred to as the “acquired texture”, and the surface at the same time is referred to as the “acquired surface”. Additionally, a region corresponding to the acquired surface is referred to as the “acquisition region”. This acquisition region corresponds to an originally existing shape region, which does not correspond to an additional shape. Among the regions included in the acquired three-dimensional data, a region located on the front side relative to the imaging unit (imaging unit 106) is referred to as the “first acquisition region,” and a region located on the back side is referred to as the “second acquisition region.”

Following step S101, the process proceeds to step S102. Step S102 corresponds to a process in which the additional shape generation unit 104a generates an additional shape. In step S102, an additional shape (vertices and surfaces) that is not present in the surface acquired in step S101 is generated. Details of the additional shape will be described below.

Following step S102, the process proceeds to step S103. Step S103 corresponds to a process in which the association processing unit 104b performs association between the surface and the texture. Typically, the association between shape information and texture information in three-dimensional data is performed through UV unwrapping. However, with respect to shape information that has been acquired from a single viewpoint, an image captured from that viewpoint can be used as a texture without performing UV unwrapping. Although the following explanation is given on the premise that UV unwrapping is not performed, UV unwrapping may be performed depending on the embodiment.

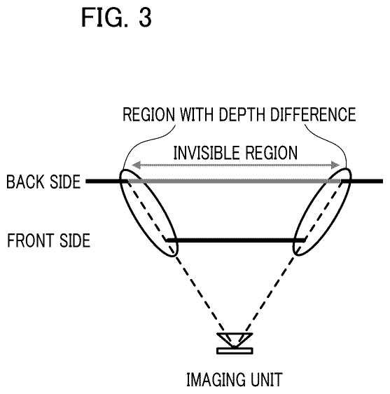

An invisible region and a region having a depth difference will be explained with reference to FIG. 3. FIG. 3 is a schematic diagram for explaining incomplete three-dimensional data. A case is assumed in which a subject is positioned at different depths on the front and back sides relative to the imaging unit (imaging unit 106). In such a case, an invisible region of the subject positioned on the back side is generated due to occlusion by the subject positioned on the front side. In the case of three-dimensional data that is composed of only surfaces in a region that is visible from the imaging unit, an invisible region may become visible when the data is rendered from a virtual viewpoint. Since no surface is generated for the invisible region of the subject that is positioned on the back side, a virtual viewpoint image in which a hole appears in the three-dimensional data is generated. Therefore, the user may perceive a sense of unnaturalness when viewing this image.

Accordingly, in the present embodiment, a process of generating a surface as an additional shape is performed for a region other than the acquisition region (visible region) (FIG. 2: S102). A region in which an additional shape is to be generated is a vicinity region of a region in which there is a depth difference in the shape, when a subject related to three-dimensional data is viewed from a surface side. In this context, the “surface” refers to the side of the polygon on which the texture is reflected. Typically, textures are reflected on the surface where the normal of the polygon is positive, and therefore, viewing the image from the surface where the sign of the normal is positive may be defined as “viewing from the surface”. Additionally, the “region having a depth difference” refers to a region in which a depth difference exists between shapes as shown in FIG. 3. A region having a depth difference can be determined by the following methods.
A method of determining it as a region where the surface is missing, such as a hole in the three-dimensional data.
A method of sequentially focusing on each polygon forming the surface, evaluating the Euclidean distance between the centroid coordinates of the focused polygon and those of adjacent polygons, and determining a region in which the evaluation value is equal to or greater than a threshold.

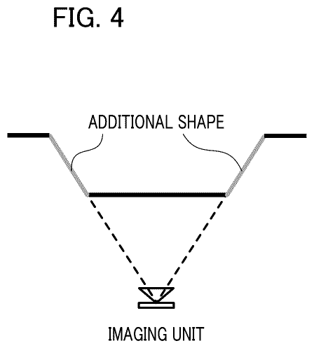

An example of the additional shape will be explained with reference to FIG. 4. Among the regions that have a depth difference when viewed from the imaging unit (imaging unit 106), a surface that connects the surface in the back-side acquisition region and the surface in the front-side acquisition region corresponds to the additional shape. The depth difference corresponds to the difference in distance information or depth information in the line-of-sight direction or the imaging direction. The additional shape can be generated by manipulating phase information such that in the vicinity of a region having a depth difference, the point cloud on the near side and the point cloud on the far side are connected, and it is not necessarily required to always add a point cloud. Thus, a process of generating an additional shape so as to connect vertices in the region having a depth difference is performed (FIG. 2: S102). As a result, even in a case in which rendering is performed from a virtual viewpoint, a hole is not visible, and a sense of unnaturalness when viewing the image can be suppressed.

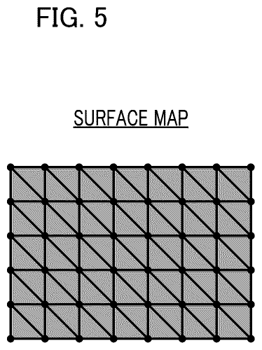

FIG. 5 is a schematic diagram illustrating a surface map. Although a surface is inherently three-dimensional information, in FIG. 5, it is represented in the form of a two-dimensional map that was obtained by perspective projection onto a certain projection plane. The surface map in FIG. 5 represents the connection relationships of the point cloud on the projection plane by a large number of line segments.

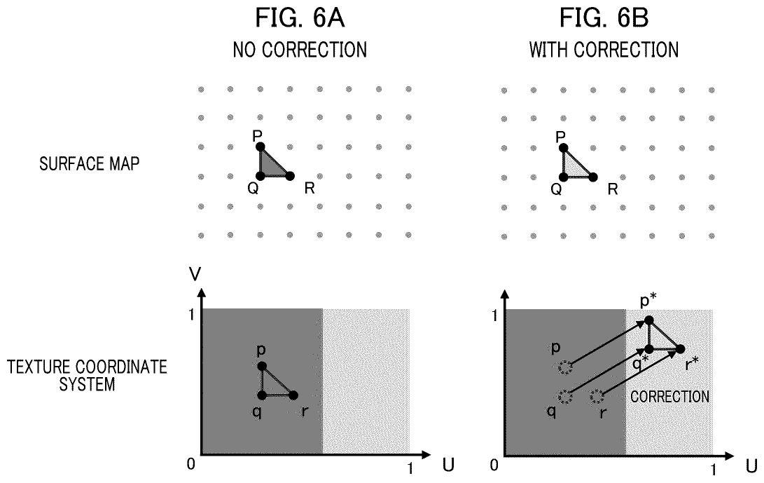

The correspondence between the surface and the texture will be explained with reference to FIG. 6A and FIG. 6B. FIG. 6A shows the correspondence between a surface map and a texture in a case in which correction of the texture coordinates is not performed. FIG. 6B shows the correspondence between a surface map and a texture in a case in which correction of the texture coordinates is performed. The horizontal axis of the texture coordinate system represents the U coordinate, and the vertical axis represents the V coordinate. The texture coordinate values are relative coordinate values normalized to a range from 0 to 1 within the texture coordinate system. Each vertex has a corresponding point in the texture coordinate system. Points in the surface map are denoted by uppercase alphabetic characters, and points in the texture coordinate system are denoted by lowercase alphabetic characters.

In FIG. 6A, the vertex P of the triangle corresponds to the point p in the texture coordinate system, the vertex Q of the triangle corresponds to the point q in the texture coordinate system, and the vertex R of the triangle corresponds to the point r in the texture coordinate system. In a case in which the three vertices P, Q, and R have a connection relationship, the region of a triangle PQR is assigned a texture corresponding to the region of a triangle pqr in the texture coordinate system. In the texture coordinate system, a dark gray region is shown on the left side and a light gray region is shown on the right side. The region of the triangle pqr is within the dark gray region. FIG. 6B illustrates the following examples of changes.
Changing the point in the texture coordinate system corresponding to the vertex P from the point p to the point p*.
Changing the point in the texture coordinate system corresponding to the vertex Q from the point q to the point q*.
Changing the point in the texture coordinate system corresponding to the vertex R from the point r to the point r*.

In the texture coordinate system, while the region of the triangle pqr is within the dark gray region, the region of a triangle p*q*r* is within the light gray region. That is, the texture assigned to the triangle PQR in the surface map is changed from dark gray to light gray. The process in which the association processing unit 104b changes the texture coordinate values in this manner is referred to as a “correction of texture coordinates,” or simply a “correction.” Additionally, the magnitude of the difference vector between the texture coordinate values before and after the correction is referred to as the “correction amount,” and the direction of the difference vector is referred to as the “correction direction.” The difference vector refers to a vector from the point p to the point p*, a vector from the point q to the point q*, and a vector from the point r to the point r* and is used to determine the correction amount and the correction direction.

In step S103 of FIG. 2, a process of setting texture coordinates for the region of the additional shape that was generated in step S102 is performed. By setting texture coordinates so that the acquired texture is assigned to the region of the additional shape, an effect of suppressing the sense of unnaturalness due to occlusion can be achieved at a lower computational cost. The grounds upon which this effect can be achieved are explained below.

As was described above, there exists prior art in which a sense of unnaturalness is suppressed by performing inpainting processing on the texture of a region that is invisible from the imaging unit (occlusion region), based on information from a visible region in the vicinity of the invisible region (acquisition region). In general, since inpainting processing is performed by editing the image itself, it has the drawback that the computational cost becomes high in cases in which the image has a high resolution.

In contrast, in the present embodiment, the determination of the texture for the occlusion region is characterized by being performed through UV assignment based on existing texture information, rather than by editing the texture. In a case in which the resolution of the shape information is lower than that of the texture, the amount of information targeted by the special assignment processing is reduced, thereby allowing further reduction in computational cost.

In the present embodiment, it is a premise that the resolution of the vertices that configure the surface is lower than the resolution of the image information. There are cases in which, as a format of three-dimensional data, color information and three-dimensional coordinate information are provided for each vertex. In the case of performing high-definition image representation, coordinate information is necessary in addition to color information, resulting in an increased data size. Therefore, reducing the resolution of shape information relative to that of image information is effective, as it enables higher-definition image representation while reducing data size. In consideration that, in many subjects, the fineness of the shape is coarser than the fineness of the color information, there are limited cases of degradation in the quality of the three-dimensional data due to reducing the resolution of the shape information so as to be lower than the resolution of the image information.

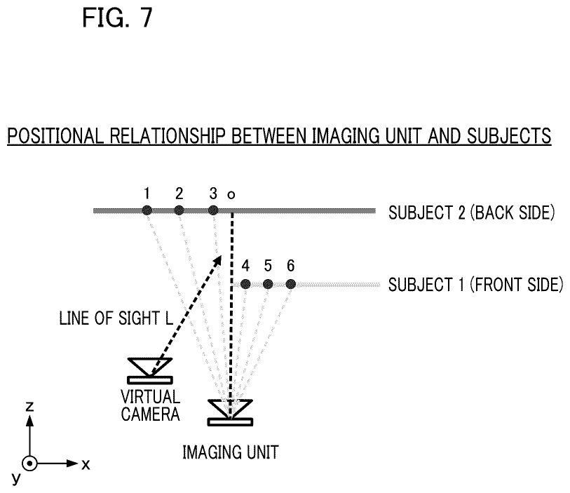

Next, an outline of the process of associating the surface and the texture (FIG. 2: S103) will be explained with reference to FIG. 7 to FIG. 9C. FIG. 7 illustrates the positional relationship between the imaging unit (imaging unit 106) and the subject in the neighborhood of the region having a depth difference. It is assumed that a first subject (hereinafter, referred to as “subject 1”) is positioned on the front side with respect to the imaging unit 106, and that its texture is light gray. It is assumed that a second subject (hereinafter, referred to as “subject 2”) is positioned on the back side with respect to the imaging unit 106, and that its texture is dark gray. The imaging unit 106 captures images of the subject 1 and the subject 2, and three-dimensional data is generated. The optical axis of the imaging unit 106 is indicated by a dotted line passing through a point o, which corresponds to the boundary line between subject 1 and subject 2. Shape information is acquired at intervals indicated by points numbered 1 to 6. The points that are indicated by 1 to 3 correspond to the subject 2, and the points that are indicated by 4 to 6 correspond to the subject 1. The resolution of the vertices that form the surface is lower than the resolution of the image information. Accordingly, it is assumed that the image information is acquired at a resolution that is finer than a resolution corresponding to the intervals between points 1 to 6.

In FIG. 7, the direction of the optical axis of the imaging unit 106 is defined as the z-axis direction, the direction perpendicular to the paper surface is defined as the y-axis direction, and the direction orthogonal to both the z-axis and y-axis directions is defined as the x-axis direction. In FIG. 7, it is assumed that the imaging unit 106 acquires distance information at a resolution of six rows in the y-axis direction and six columns in the x-axis direction. The points numbered 1 to 6 correspond to column numbers. Additionally, the difference in texture coordinates between a certain vertex and an adjacent vertex is constant for all vertices. In this context, the column number is denoted as c, and the row number is denoted as r. The U coordinate corresponding to the column number c is denoted as Uc, and the V coordinate corresponding to the row number r is denoted as Vr. The U coordinate corresponding to the column number c+1 is denoted as U_{c-1}, and the V coordinate corresponding to the row number r+1 is denoted as Vᵣ₊₁. It is assumed that, for arbitrary c and r, and constants ΔU and ΔV, the formulae ΔU=U_{c+1}−U_{c} and ΔV=Vᵣ₊₁−Vᵣ are satisfied.

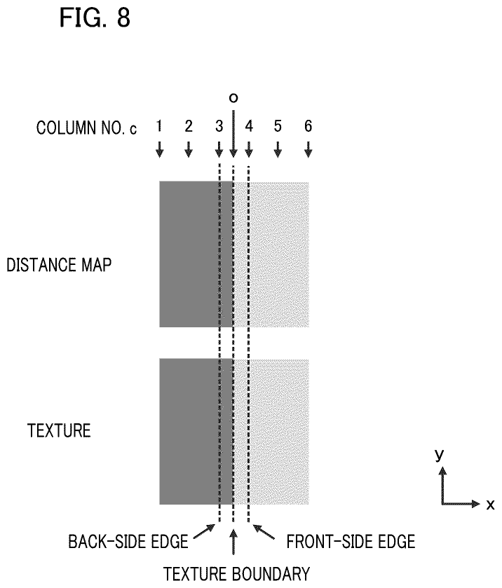

FIG. 8 is a diagram showing a distance map and texture that are acquired in the configuration shown in FIG. 7. The upper and lower direction on the paper corresponds to the y-axis direction, and the right to left direction on the paper corresponds to the x-axis direction. The column numbers c=1 to 6 and the point o are indicated. The dotted line passing through point “o” represents the boundary of the texture. Since the boundary of the subject corresponds to the optical axis of the imaging unit 106, the color of the front subject (light gray) and the color of the back subject (dark gray) are switched at the center of the texture in the x-axis direction. Column number c=3 corresponds to the back-side edge, and column number c=4 corresponds to the front-side edge.

On the other hand, the shape information is acquired at a pitch indicated by points 1 to 6 in FIG. 7. The edge (the set of vertices closest to the boundary) of subject 1 corresponds to the fourth column, and the edge of subject 2 corresponds to the third column. Thus, due to a difference in resolution, a misalignment occurs between the switching of shapes and the switching of textures for each subject. The misalignment between shapes and textures may result from the difference in resolution explained here, as well as from various other factors to be described below.

The virtual camera shown in FIG. 7 schematically represents a situation in which the subject is assumed to be imaged from a virtual viewpoint. The virtual camera represents a camera position assumed without actually moving the imaging unit 106, and indicates a line of sight L. For example, it is desirable that the texture of the subject 2 (dark gray) be assigned in a case in which imaging is performed in the direction of the line of sight L (between point 3 and point 4) from the position of the virtual camera (virtual viewpoint). However, loss of information occurs in the region of the subject 2 that is occluded by the subject 1 from the position of the imaging unit 106, and thus the issue arises as to how the loss of information should be supplemented.

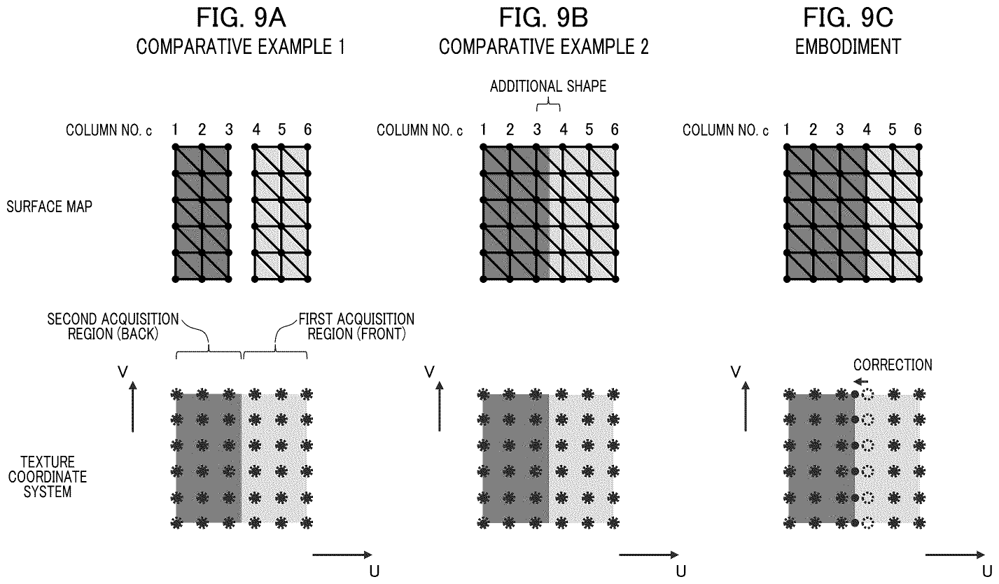

FIG. 9A and FIG. 9C are schematic diagrams illustrating a surface map and a texture coordinate system composed of vertices arranged in six rows by six columns. Each column numbered 1 to 6 shown in the vertices of FIG. 9A and FIG. 9C corresponds to each of the points 1 to 6 in FIG. 7. FIG. 9A represents a first comparative example, FIG. 9B represents a second comparative example, and FIG. 9C represents the embodiment. In each drawing, the surface map is arranged in the upper portion, and the texture coordinate system is arranged in the lower portion.

The first comparative example of FIG. 9A is an example in which three-dimensional data is generated from only the acquired information without generating an additional shape. In the first comparative example, the additional shape is not generated, and correction of texture coordinates is not performed. Here, among the six columns of vertices, the vertices having the column numbers c=1 to 3 belong to the back-side acquisition region in FIG. 3, and the vertices having the column numbers c=4 to 6 belong to the front-side acquisition region in FIG. 3. In the first comparative example, a surface is not generated between the vertices of the column number 3 and the vertices of the column number 4. Therefore, when viewed from the virtual viewpoint in FIG. 7 (refer to the line of sight L), a hole is visible, resulting in a sense of unnaturalness when viewing the image.

In the second comparative example of FIG. 9B, an additional shape is generated, whereas correction of texture coordinates is not performed in the association process (FIG. 2: S103). In the surface map, a surface connecting the surface in the back-side acquisition region and the surface in the front-side acquisition region, as viewed from the imaging unit (imaging unit 106), is generated as an additional shape. The vertices of the column number 3 and the vertices of the column number 4 are connected to form a surface. That is, a surface that includes both a vertex of the column number 3 and a vertex of the column number 4 corresponds to the additional shape. In the second comparative example, correction of texture coordinates is not performed. Therefore, a mixed texture composed of the texture of the subject 1, which is located on the front side and the texture of the subject 2, which is located on the back side, is assigned to the additional shape surface. As described above (refer to FIG. 7), although it is expected that the texture of the subject 2, which is located on the back side, is visible in the region between the points 3 and 4, the texture of the subject 1, which is located on the front side, is actually visible in that region. This may cause a sense of unnaturalness when viewing the image.

The embodiment of FIG. 9C is an example in which an additional shape is generated, and correction of texture coordinates is performed during the association process (FIG. 2: S103). In the texture coordinate system, a dotted circle represents the texture coordinate position before correction during the association process (FIG. 2: S103). A black dot represents the texture coordinate position after correction during the association process. It is desirable that the texture correction be performed such that the texture of the second acquisition region is assigned to the additional shape. The U coordinate before correction for a vertex belonging to a column number c is denoted as U_{c}, and the U coordinate after correction is denoted as U*_{c}. At c=4, the U coordinate is set such that “U*₄≤U₄−ΔU/2” is satisfied. The texture coordinate positions before correction (dotted circles) are changed to texture coordinate positions after correction (black dots). As a result, the texture of the subject located on the back side can be assigned to the additional shape. Consequently, it becomes possible to easily reduce the sense of unnaturalness that arises in a case in which the occlusion region is viewed from a virtual viewpoint.

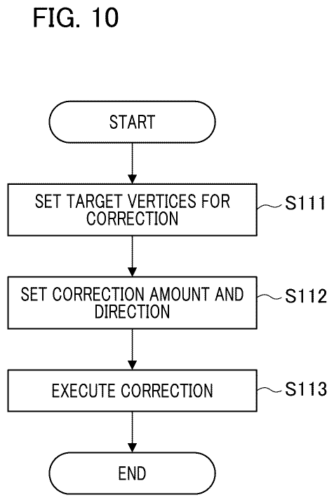

Next, processing during the association process (FIG. 2: S103) will be explained with reference to FIG. 10. In step S111, a process of setting vertices as targets for texture coordinate correction is performed. For example, a region having a large depth difference can be determined as a region in which a gradient value is equal to or greater than a threshold, by obtaining a gradient in a distance map. The distance map is map information that holds distance information as pixel values and represents the distribution of depth information in the depth direction of the subject. For example, the depth information can be calculated by a known method using phase difference detection information on the imaging plane, image shift information, defocus information, and the like. In the determined region having a large depth difference, a vertex to be corrected can be set by searching for a front-side edge within the interior and the vicinity of the region (a front-side vertex adjacent to a back-side distance value).

After step S111, the process proceeds to step S112, in which a process of setting the correction amount and the correction direction of the texture coordinate values is performed. The correction amount of the texture coordinates may be a fixed value or a variable value. For example, ΔU /2 is set as a fixed value. Additionally, the correction direction is set as a direction that is orthogonal to the front-side edge that was searched for in step S111 and that faces toward the back-side edge.

After step S112, the process proceeds to step S113, in which a correction processing for the texture coordinate values is executed. The process of updating the texture coordinate value is executed by adding a correction value, based on the correction amount and the correction direction that were set in step S112, to the texture coordinate value before correction at each vertex that was set as a correction target in step S111.

The present invention is not limited to the example shown in FIG. 10 and may be realized by other embodiments. For example, in the process of determining a region having a large depth difference in step S111, it is possible to determine a region in which the Euclidean distance between the three-dimensional coordinate values of adjacent vertices is equal to or greater than a threshold. Additionally, the correction target region in step S111 may also include back-side edge vertices and vertices in the vicinity of these back-side edge vertices instead of only including front-side edge vertices. Additionally, in the process of setting the correction amount in step S112, the correction amount may be set so as to exceed a predetermined correction amount (fixed value) after detecting a positional shift between the texture and the shape. Additionally, it is also possible to perform settings such that the correction amount is dynamically changed according to the depth difference of the shape.

According to the present embodiment, the texture coordinates of the vertices that configure the additional shape are set so that the texture of the acquisition region is assigned thereto, thereby enabling a further reduction in computational cost while suppressing unnaturalness when viewing the image. In the embodiment of FIG. 9C, association is performed such that the texture is also continuously assigned to a region in which the surface is continuous. Although the present embodiment is not limited to this configuration, in a case in which a portion of a continuous surface refers to a region that is different from a region that is referred to by the other portions, the texture reflected at the boundary may appear unnatural, like patchwork. From the viewpoint of suppressing visual inconsistency at texture boundaries, it may assign a continuous texture region to a region where the surfaces are continuous.

### First Modified Example

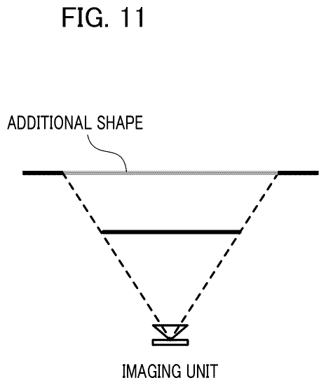

In the present modified example, another example of an additional shape is shown. FIG. 11 illustrates an example of an additional shape that is generated so as to be continuous with the surface of the back-side acquisition region, and discontinuous with the surface of the front-side acquisition region, as viewed from the imaging unit (imaging unit 106). In this case, in the additional shape generation process (FIG. 2: S102), it is necessary to add point clouds and form surfaces. The addition of the point cloud may be performed, for example, by extrapolation based on information of the back-side acquisition region. By generating the additional shape to be continuous with the back-side acquisition region, it becomes possible to suppress a sense of unnaturalness in viewing, since a hole is not visible even in a case in which rendering is performed from a virtual viewpoint.

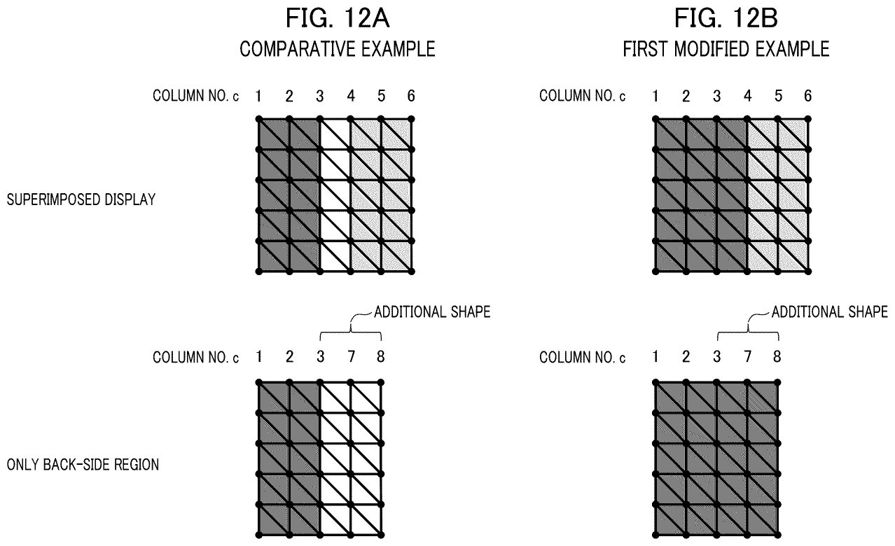

With reference to FIG. 12A and FIG. 12B, the details of the association process (FIG. 2: S103) in the present modified example will be explained. FIG. 12A illustrates a comparative example of a surface map in the vicinity of a region that has a depth difference, and FIG. 12B illustrates the present modified example.

In the present modified example, since two or more vertices and surfaces may exist along a ray extending from the imaging unit, it is not possible to represent all shapes with a single surface map as shown in FIG. 9A and FIG. 9C. Accordingly, in FIG. 12A and FIG. 12B, the upper portion shows a diagram in which surface maps are superimposed in the order visible from the imaging unit, and the lower portion shows a diagram in which the back-side acquisition region and the additional shape are shown. The acquired surface has six columns of vertices. The vertices having the column numbers c=1 to 3 belong to the back-side acquisition region in FIG. 11, whereas the vertices having the column numbers c=4 to 6 belong to the front-side acquisition region in FIG. 11. Additionally, in the additional shape in the present modified example, vertices having column numbers 7 and 8 are added in the vicinity of the vertex having the column number 3, and a surface is formed by connecting these vertices such that continuity with the back-side acquisition region is established. In this case, a surface that is formed by the vertices having the column numbers 3, 7, and 8 configures the additional shape. From the viewpoint of the imaging unit, a part of the additional shape (a surface formed by the vertices having the column numbers 3, 7, and 8) is occluded by the surface formed by the front-side acquisition region (the surface formed by the vertices having the column numbers 4 to 6). Accordingly, in the superimposed diagram in the upper portion, the vertices having the column numbers 7 and 8 and the surface formed by these vertices are not displayed.

In the comparative example of FIG. 12A, the column numbers 1 to 3 belong to an acquisition region and are represented by applying a uniform dark gray texture, and the column numbers 4 to 6 belong to another acquisition region and are represented by applying a uniform light gray texture. On the other hand, the vertices of the column numbers 7 and 8 are newly added vertices, and color information to be assigned to the region including these vertices is not included in the acquired image. That is, in the comparative example, coordinate values to be set as U₇ and U₈ do not exist, and in FIG. 12A, the texture information in the region of the additional shape is represented in white.

In the present modified example of FIG. 12B, the U coordinates of the acquisition region are assigned to the vertices that configure the additional shape. Specifically, a process of setting the U coordinates so that “U*7<U₃+ΔU/2, U*8<U₃+ΔU/2” are satisfied is executed. Thus, by setting the texture coordinates of the vertices that configure the additional shape such that the texture of the acquisition region is assigned thereto, it is possible to suppress a sense of unnaturalness when viewing the image and also to reduce the computational cost.

### Second Modified Example

The three-dimensional data that is acquired during the three-dimensional data acquisition process (FIG. 2: S101) is generated based on imaging information that is captured by the imaging unit. In the present modified example, the imaging information is used in the process of determining the target region for generating the additional shape during the process of generating the additional shape (FIG. 2: S102). For example, the imaging unit 106 may have a stereo camera configuration, and may acquire, as imaging information, image information having parallax or distance map information. In the present modified example, with respect to the information of the distance map that is acquired by the imaging unit, information in the vicinity of a distance edge that is detected by an edge detection method can be used as auxiliary information for a target region in which an additional shape is to be generated. It is possible to improve the accuracy of detection of a target region (occlusion region) in which an additional shape is to be generated, based on the information that is acquired by the imaging unit.

### Third Modified Example

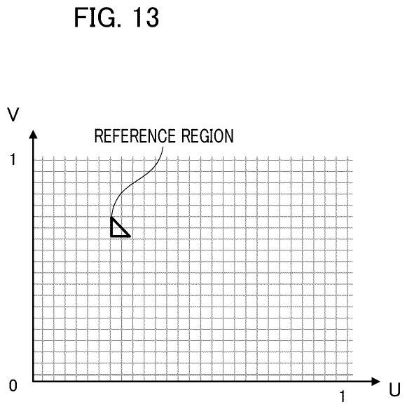

The present modified example is not limited to an example in which each polygon within the additional shape refers to a different region of the texture, and each polygon may refer to the same region, as in the present modified example. FIG. 13 is a diagram illustrating a reference region on the texture coordinates. The horizontal axis represents the U coordinate, and the vertical axis represents the V coordinate. In the association process (FIG. 2: S103), texture coordinates may be set such that the polygons within the additional shape refer to a specific minute region in the texture coordinate system (see FIG. 13). Here, the term “minute region” is defined as a region in which a variation in pixel values (RGB values) within the region is sufficiently small. In a case in which a region with small variation in pixel values is referenced on the texture, it is necessary to set the size of the minute region to be sufficiently small such that the amount of variation in pixel values within the region becomes sufficiently small. As one example, a region having a size corresponding to approximately 2×2 pixels is set as the minute region. On the other hand, in a case in which a region with small variation in pixel values is referenced on the texture, the minute region may be set to be large, as long as the amount of variation in pixel values within the region remains sufficiently small. As one example, it is possible to set, as the minute region, a region corresponding to a size of approximately 50×50 pixels.

For example, a white region on the texture is assumed, and the RGB values thereof are defined as (255, 255, 255). In a case in which a minute region composed of three points within a white region is set as a reference region, and texture coordinates are set such that all polygons within the additional shape refer to the minute region, the occlusion region in the three-dimensional data is filled with white.

Additionally, for the minute region, image features on the background side of the subject may be detected, and a region in which the image feature amount is the largest may be set as the minute region. The processing flow will be explained assuming a scene in which a single subject is present on a monochromatic background. First, a process of identifying a background region (a region on the background side) is performed by using a subject region detection unit and the like based on deep learning. An average value of pixel values in the background region is obtained, and relative coordinates (texture coordinates) of a region having the texture pixel values that are closest to the average value are calculated. Based on statistical values of pixel values in a background region of the texture, a process of correcting texture coordinates is performed so that the texture is assigned to the additional shape.

In the present modified example, a specific region in the texture coordinate system is consistently referenced. By correcting the texture coordinates of the additional shape so as to consistently refer to a minute region in which the amount of variation in pixel values on the texture coordinate system is equal to or less than a threshold and the pixel variation is sufficiently small, it is possible to achieve an effect of inpainting the occlusion region with a solid color. For example, in a scene in which the region on the occluded side is clearly a solid color, it is possible to effectively suppress a sense of unnaturalness in the vicinity of regions with depth discontinuity.

### Fourth Modified Example

In the present modified example, a process will be explained in which pixel values of a minute region in the texture coordinate system are corrected, and texture coordinates of the additional shape are corrected such that the minute region is referenced.

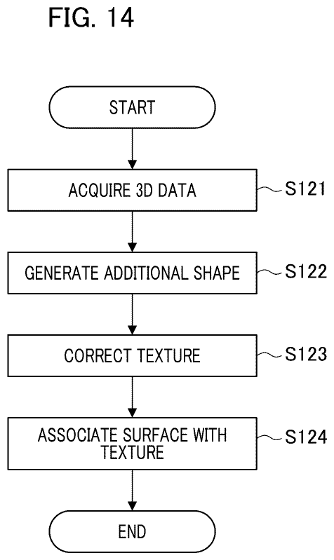

Image processing in the present modified example will be explained with reference to FIG. 14. In the present modified example, since the process in step S121 is the same as the process in step S101 of FIG. 2, and the process in step S122 is the same as the process in step S102 of FIG. 2, detailed explanations of these steps are omitted, and only the differences will be explained. After step S122, the process proceeds to step S123. Step S123 corresponds to a texture correction process. The texture correction unit 104c performs processing for correcting pixel values of a minute region in the texture. Although a premise of the present embodiment is that inpainting processing is not performed so as to reduce computational cost, correction of pixel values in a minute region (for example, correction over several pixels) is performed. In a case of such a degree of correction, the impact on the overall processing time is minor, and the possibility of an increase in computational cost is low.

In step S123, the following methods are provided for setting the corrected pixel values by the texture correction unit 104c.
A method of setting a predetermined pixel value such as black.
A method of setting pixel values based on statistical values of pixel values in a background region of the texture, as was explained in the third modified example.

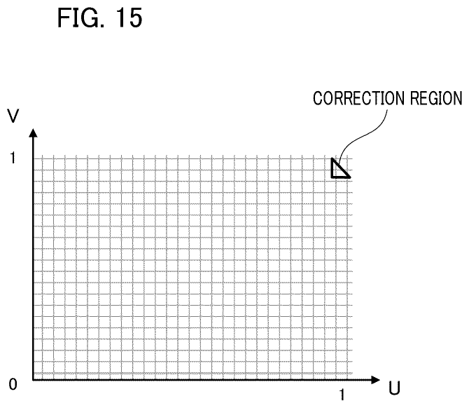

The region to be corrected (correction region) on the texture coordinate system may be a region of the texture that is not assigned to the acquired surface. FIG. 15 is a diagram illustrating a correction region on the texture coordinate system according to the present modified example. The horizontal axis represents the U coordinate, and the vertical axis represents the V coordinate. For example, in a case in which no texture is assigned to a peripheral region of the image, the peripheral region on the texture coordinates is set as a correction region.

Step S124 corresponds to the association process between the surface and the texture. In step S124, a process of correcting the texture coordinates of the region associated with the additional shape is performed such that the corrected texture from step S123 is referenced.

According to the present modified example, it is possible to achieve an effect of inpainting the occlusion region with a solid color. Although this effect is similar to that of the third modified example, the present modified example makes it possible to assign, as the texture of the additional shape, a color that is not originally included in the texture, and therefore, an effect of suppressing a sense of unnaturalness can be expected in a wider variety of scenes.

### Fifth Modified Example

In the present modified example, processing based on statistical values of areas of reference regions in the texture coordinate system will be explained. A statistical value refers to values such as a mean value, a median value, a mode, and the like. Texture information is assigned such that the statistical values of the areas of reference regions in the texture coordinate system that are referenced by the respective polygons within the additional shape are smaller than the statistical values of the areas of reference regions referenced by the respective polygons outside of the additional shape. This processing is executed by the association processing unit 104b.

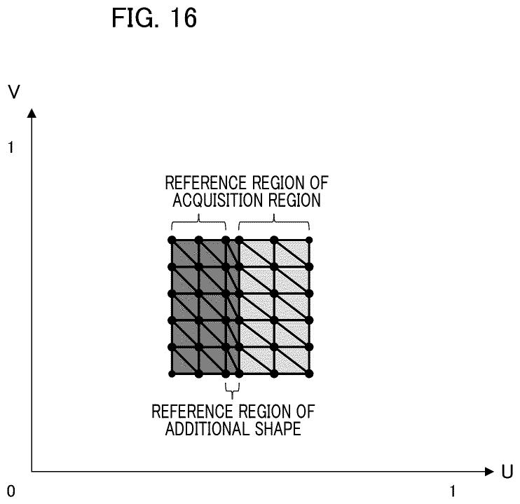

FIG. 16 is a diagram illustrating the reference region on the texture coordinates according to the present modified example. The horizontal axis represents the U coordinate, and the vertical axis represents the V coordinate. An example is shown in which the texture is assigned in the same setting as in the embodiment of FIG. 9C. In FIG. 16, the area of the region referenced by each polygon in the additional shape is set so as to be smaller than the area of the region referenced by each polygon in the acquisition region. The acquisition region is composed of a shape and a texture that are visible from the imaging unit. In contrast, the additional shape is composed of a shape and a texture that are not visible from the imaging unit. In a case in which a subject related to three-dimensional data is viewed from a viewpoint in the vicinity of the imaging unit, a region that is visually recognized is predominantly composed of the acquisition region, and the additional shape configures only a part thereof. Accordingly, in many cases, the acquisition region is more important than the additional shape in terms of information.

In the present embodiment, it is a premise that the texture is continuously assigned to the region where the surface is continuous. In this case, it is necessary to perform correction that reduces the texture region to be assigned to the acquisition region by the portion of the acquired texture that is assigned to the additional shape. Due to the correction, the corresponding points between the texture and the shape in the acquired information are shifted from their original positions, and if the correction amount is large, there is a possibility that a sense of unnaturalness may occur. Accordingly, in the present modified example, in order to reduce the correction amount, the area of the region that is referenced in the texture coordinate system by each polygon in the additional shape is set to be relatively small.

### Sixth Modified Example

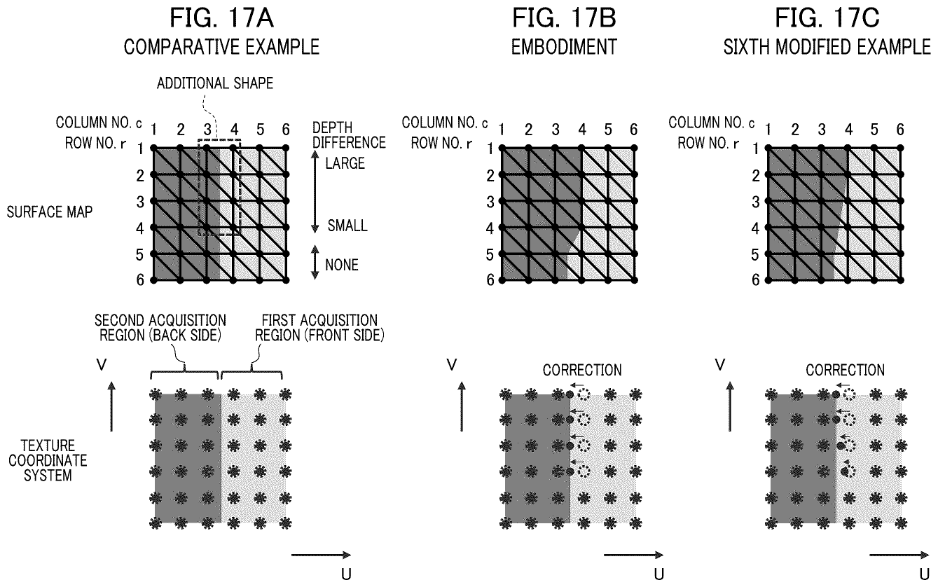

In the present modified example, the process of changing the correction amount in the association between the surface and the texture according to the depth difference is explained. FIG. 17A and FIG. 17C are schematic diagrams of a surface map and a texture coordinate system composed of vertices arranged in six rows by six columns. Although in FIG. 17A and FIG. 17C, there is a depth difference between the third column and the fourth column, the degree of the depth difference decreases from the first row to the fourth row, and the fifth and sixth rows represent cases in which there is no depth difference. FIG. 17A illustrates a comparative example, FIG. 17B illustrates an embodiment, and FIG. 17C illustrates the present modified example. In each drawing, the surface map is arranged in the upper portion, and the texture coordinate system is arranged in the lower portion. The display of dotted circles, black dots, and the like is as was explained in FIG. 9A and FIG. 9C. The column numbers c=1 to 6 and the row numbers r=1 to 6 are indicated, and the coordinates of the vertices are represented as (r, c).

The comparative example of FIG. 17A is an example in which a surface connecting the third column and the fourth column is generated as an additional shape, and no correction is performed in the texture coordinate system. The additional shape is a shape having a depth difference from (r, c)=(1, 3) to (4, 4). In the additional shape, the texture of the subject that is positioned on the front side and the texture of the subject that is positioned on the back side are mixed, which may cause a sense of unnaturalness when viewing the image.

The embodiment of FIG. 17B is an example in which a surface connecting the third column and the fourth column is generated as an additional shape, and correction of the texture coordinate system is performed with a uniform correction amount. The texture coordinates corresponding to the vertices of (r, c)=(1, 4) to (4, 4) are uniformly corrected in the negative direction of the U coordinate. As a result, in the additional shape that has a depth difference from (r, c)=(1, 3) to (4, 4), the texture of the subject positioned on the back side is consistently assigned, and thus it is possible to suppress a sense of unnaturalness when viewing the occlusion region. However, in this embodiment, correction is performed with a constant correction amount, both in regions with a large depth difference and in regions with a small depth difference. Therefore, at the boundary between a region with a depth difference and a region without a depth difference (the fourth to fifth rows), a sudden misalignment of the texture may occur. Depending on the subject, this misalignment of the texture may lead to a sense of unnaturalness when viewing the image.

The present modified example of FIG. 17C is an example in which a surface that connects the third column and the fourth column is generated as an additional shape, and correction of the texture coordinate system is performed with different correction amounts according to the depth difference. The texture coordinates corresponding to the vertices of (r, c)=(1, 4) to (4, 4) are corrected in the negative direction of the U coordinate according to the depth difference. The correction amount is large in a case in which the depth difference is relatively large, and the correction amount is small in a case in which the depth difference is relatively small. For example, the correction amount is set so as to be proportional to the depth difference. As a result, compared to the embodiment of FIG. 17B, an effect is achieved in which the texture misalignment at the boundary between a region with a depth difference (or a region with a large depth difference) and a region with no depth difference (or a region with a small depth difference) becomes less noticeable.

In a region where the depth difference is relatively small (refer to (r, c)=(2, 3) to (4, 4) in FIG. 17A and FIG. 17C), there may be cases in which the texture of the subject on the front side is included in the additional shape. In the present modified example, this degree is reduced compared to a case in which no correction of the texture coordinates is performed. Additionally, as the depth difference is smaller, the area where occlusion appears from a virtual viewpoint becomes small, and therefore, even if the texture of the subject on the front side is included in the additional shape, it is less likely to be noticeable.

### Seventh Modified Example

In the present modified example, a misalignment detection process is further included to detect an amount of misalignment between the shape and the texture in a region having a depth difference. The correction amount in the process of associating the surface with the texture is set to be equal to or greater than the detected amount of misalignment.

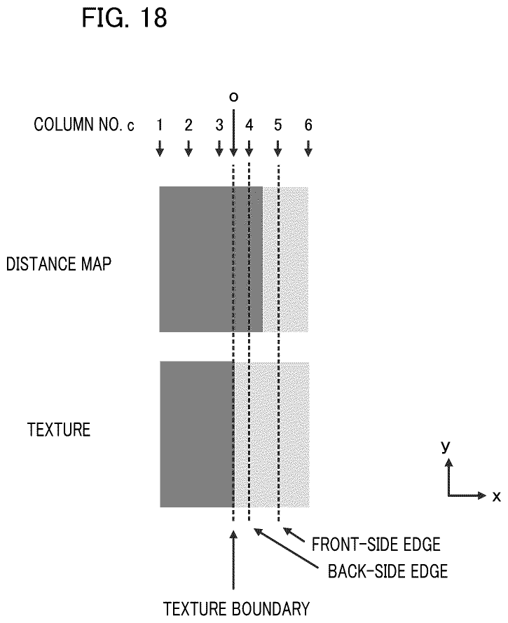

FIG. 18 illustrates an example in which a misalignment exists between a distance map and a texture in the data acquired by the configuration of FIG. 7. The boundary of the distance map is shifted in the x-axis direction relative to the boundary of the texture. A difference from FIG. 8 is that, with respect to the texture boundary between the third and fourth columns, the back-side edge in the shape information corresponds to the fourth column, and the edge on the front side corresponds to the fifth column. For example, in a case in which the distance map is acquired by stereo matching of a disparity image, the distance may not be accurately measured with respect to the disparity value at a depth edge. Compared to the subject 1 in FIG. 7, in a case in which the subject 2 has higher contrast, the disparity value of the subject 2 may be assigned in the vicinity of the edge, and a distance map that is misaligned from the actual boundary, as shown in FIG. 18, may be obtained. In a case in which a misalignment occurs between the texture and the shape, the misalignment can be reduced by appropriately setting the correction amount of the texture coordinate values.

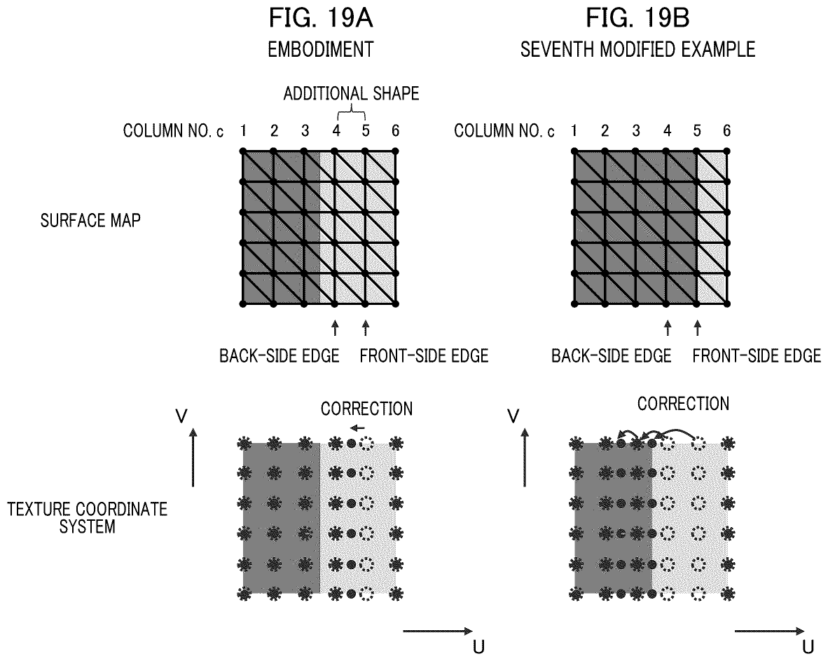

FIG. 19A and FIG. 19B are schematic diagrams of a surface map and a texture coordinate system composed of vertices arranged in six rows by six columns. In the examples of FIG. 19A and FIG. 19B, the additional shape is a surface that connects the vertices of the fourth column and the fifth column, and the vertices targeted for correction of texture coordinate values include the vertices of the fifth column and the vertices from the third to the fifth column. FIG. 19A represents the embodiment, and FIG. 19B represents the present modified example. In each drawing, the surface map is arranged in the upper portion, and the texture coordinate system is arranged in the lower portion. The display of dotted circles, black dots, and the like is as was explained in FIG. 9A and FIG. 9c.

The embodiment of FIG. 19A is an example in which the correction amount is set to ΔU/2. The amount of misalignment regarding the shape information and the texture information in the setting of FIG. 18 is greater than ΔU/2. Therefore, even after the correction, the texture coordinate values of the vertices of the fifth column remain as the texture coordinate values corresponding to subject 1. As a result, it may not be possible to assign the texture of the backside (subject 2) to the additional shape, which may lead to a sense of unnaturalness in viewing.

In the present modified example of FIG. 19B, the correction amounts are as follows.
The correction amount of the texture coordinates for the vertices of the fifth column is 3ΔU/2.
The correction amount of the texture coordinates for the vertices of the fourth column is ΔU.
The correction amount of the texture coordinates for the vertices of the third column is ΔU/2.

According to the present modified example, even in a case in which a misalignment exists between the texture and the shape, it is possible to assign the texture of the subject positioned on the back side to the additional shape by setting a correction amount equal to or greater than the amount of the misalignment. Note that the detection process of the amount of misalignment can be realized, for example, by comparing an edge detection result of the texture and an edge detection result of the distance map.

### Eighth Modified Example

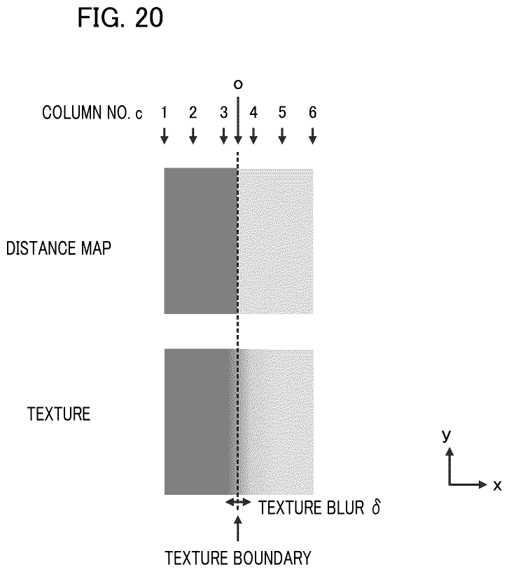

In the present modified example, processing is performed in which a correction amount in the association between the texture and the shape is set based on defocus information of the imaging optical system related to the texture. FIG. 20 illustrates an example in which the texture includes blurring in the data that was acquired by the configuration of FIG. 7. A difference from FIG. 8 is that there is a spread in the texture at the boundary between the subject 1 and the subject 2 caused by blurring (denoted as δ). This blurring is assumed to be mainly caused by defocus from the focus position (in-focus position) in the imaging optical system.

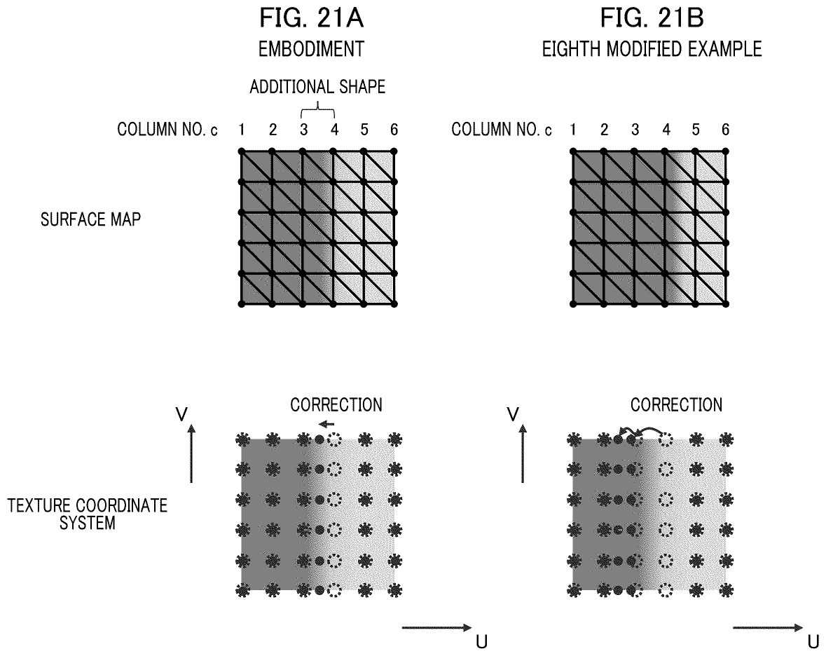

FIG. 21A and FIG. 21B are schematic diagrams of a surface map and a texture coordinate system composed of vertices arranged in six rows by six columns. In the examples of FIG. 21A and FIG. 21B, the additional shape is a surface connecting the vertices of the third column and the fourth column, and the vertices that are targeted for correction of the texture coordinate values are the vertices of the fourth column, or the vertices of the third and fourth columns. FIG. 21A illustrates the embodiment and FIG. 21B illustrates an example of the present modified example. In each drawing, the surface map is arranged in the upper portion, and the texture coordinate system is arranged in the lower portion. The display of dotted circles, black dots, and the like is as was explained in FIG. 9A and FIG. 9C.

In the embodiment of FIG. 21A, the correction amount is set to ΔU/2. The texture coordinates corresponding to the vertices in the fourth column are located at the boundary between the subject 1 and the subject 2, and due to a spread in the texture caused by blurring, the texture of the subject 1 (the front side) remains on the additional shape. While the sense of unnaturalness caused by occlusion can be suppressed, a slight sense of unnaturalness may remain when viewing the image.

In the present modified example in FIG. 21B, the correction amounts are as follows.
The texture coordinate correction amount for the vertices of the fourth column is ΔU/2+δ/2.
The texture coordinate correction amount for the vertices of the third column is ΔU/4+δ/4.
   Even in a case in which there is a spread in the texture caused by blurring, according to the present modified example, it is possible to assign only the back-side texture to the additional shape by setting the correction amount to be equal to or greater than the amount of blurring. It should be noted that the estimation of the amount of blurring can be performed, for example, by calculating a defocus amount based on information regarding the imaging optical system and information regarding the distance between the imaging unit and the subject.

### Ninth Modified Example

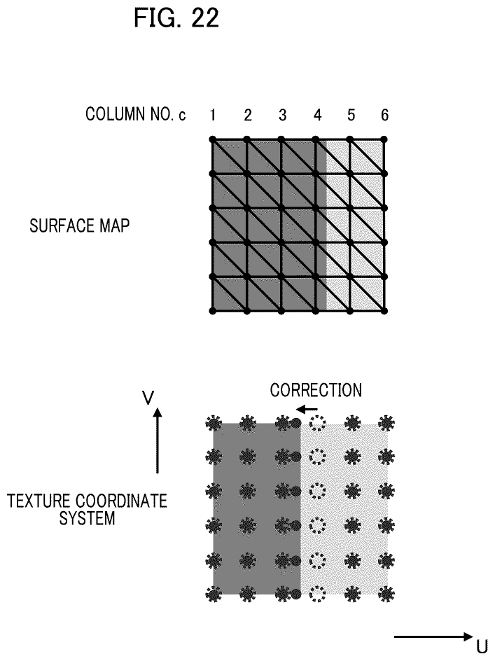

In the present modified example, processing is explained that is executed by the association processing unit 104b such that a sense of unnaturalness is suppressed in a case in which the texture on the back side is assigned to the surface on the front side. FIG. 22 is a schematic diagram of a surface map and a texture coordinate system composed of vertices arranged in six rows by six columns. A comparative example is shown in which the correction amount of the texture coordinates at the vertices of the fourth column is set to 3ΔU/4 in the data acquired by the configuration of FIG. 7. The texture of the subject 2 (the back side) is included between the corrected texture coordinates of the vertices of the fourth column and the texture coordinates of the vertices of the fifth column. Therefore, a part of the texture of the subject on the back side is assigned to the surface on the front side, possibly resulting in a sense of unnaturalness when viewing the image.

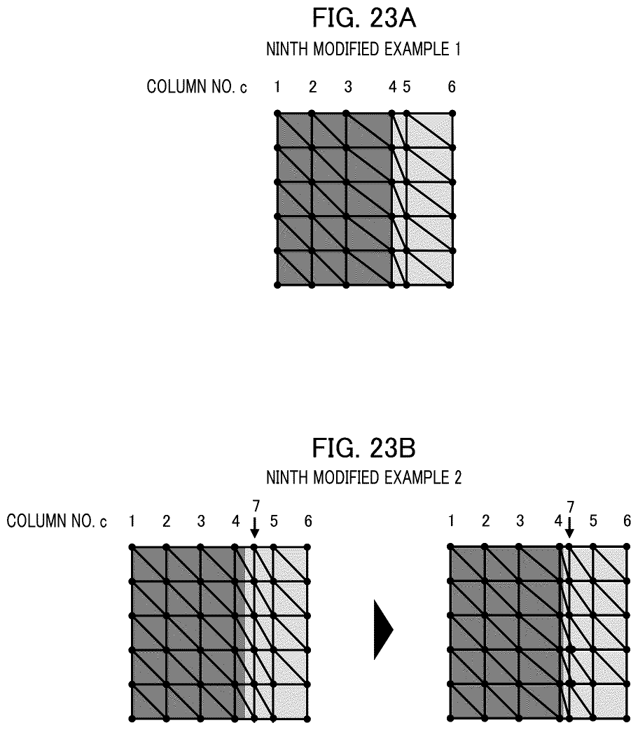

FIG. 23A and FIG. 23B are schematic diagrams illustrating surface maps according to the present modified example. FIG. 23A illustrates a first example of the present modified example, and FIG. 23B illustrates a second example of the present modified example. In one mode of the present modified example, a shape modification process is provided in which the vertex coordinates are corrected such that the area of a polygon within the first acquisition region is reduced, thereby making it more difficult to visually recognize the texture of the subject on the back side that has been assigned to the polygon on the front side.

In the first example of FIG. 23A, within the first acquisition region, a process of correcting the vertex coordinate values of the fourth column and the vertex coordinate values of the fifth column is performed such that the area of the polygon composed of the vertices of the fourth and fifth columns becomes smaller. The texture of the subject 2 that is included in the first acquisition region becomes less visible as the interval between the vertices of the third and fourth columns increases and the interval between the vertices of the fourth and fifth columns decreases. The process of correcting the vertex coordinate values can be realized, for example, by smoothing the coordinate values of the vertices of the fourth and fifth columns with a predetermined block size. Additionally, a parallel translation (not illustrated) is performed such that the surface from the vertices of the first column to the vertices of the fourth column and the surface from the vertices of the fifth column to the vertices of the sixth column approach each other. As a result, a process of reducing the polygon composed of the vertices of the fourth and fifth columns is performed.

In the second example shown in FIG. 23B, a process of adding a vertex within the first acquisition region is included. A process of reconstructing the surface is performed by adding vertices of a seventh column between the vertices of the fourth column and the vertices of the fifth column. By correcting the vertex coordinate values so that the area of the polygon composed of the vertices of the fourth and seventh columns becomes smaller, the texture of the subject 2 that is included in the first acquisition region becomes less visible.

### Tenth Modified Example

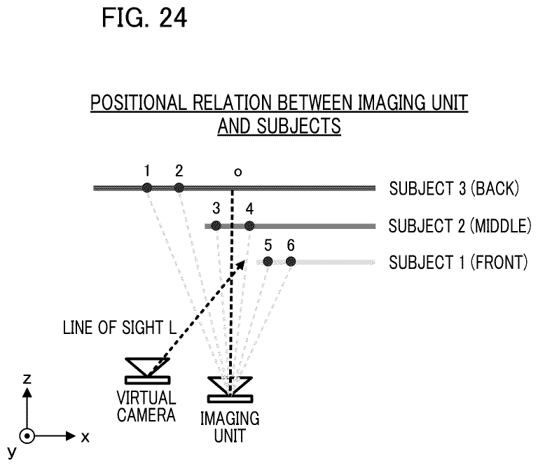

In the present modified example, a process of evaluating at least one of a color difference and a continuity of shape in the setting of the second acquisition region will be explained. FIG. 24 is a diagram illustrating a positional relation between an imaging unit and subjects according to the present modified example. With reference to the imaging unit, the subject that is positioned closest to the imaging unit is referred to as a “subject 1”, the subject that is positioned in the middle is referred to as a “subject 2”, and the subject that is positioned farthest from the imaging unit is referred to as a “subject 3”. Additionally, it is assumed that three-dimensional data obtained by capturing the subjects 1 to 3 with the imaging unit is to be rendered from a virtual camera viewpoint. The distance measurement points are defined as points 1 and 2 for the subject 3, as points 3 and 4 for the subject 2, and as points 5 and 6 the for subject 1. As in the case of FIG. 7, it is also assumed in FIG. 24 that the resolution of the texture is higher than the interval between the distance measurement points (the resolution of the shape).

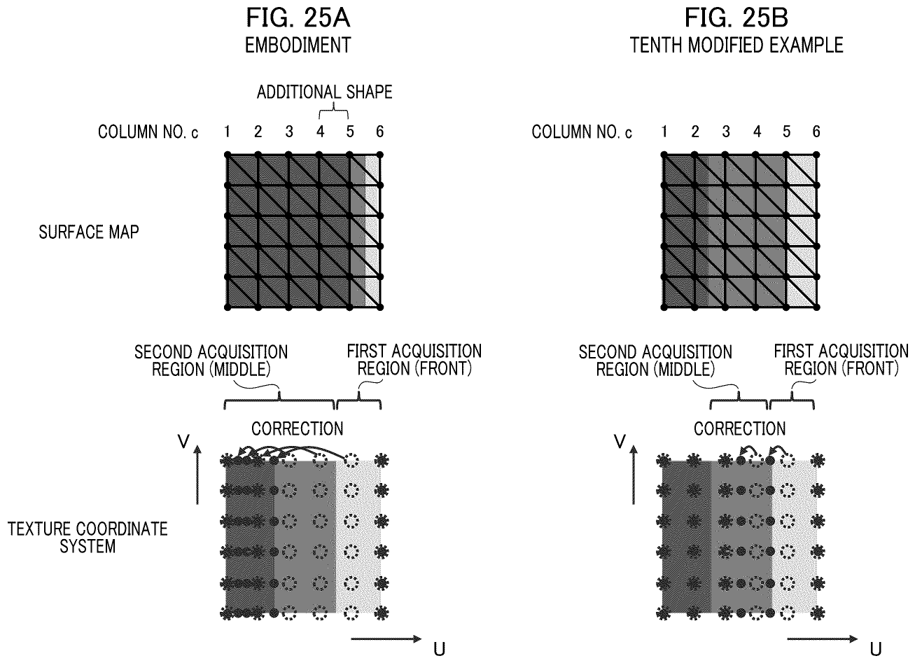

FIG. 25A and FIG. 25B are schematic diagrams of a surface map and a texture coordinate system that is composed of vertices arranged in six rows by six columns. FIG. 25A illustrates the embodiment, and FIG. 25B illustrates an example of the present modified example. In each drawing, the surface map is arranged in the upper portion, and the texture coordinate system is arranged in the lower portion. The display of dotted circles, black dots, and the like is as explained in FIG. 9A and FIG. 9C.

In the embodiment of FIG. 25A, the first acquisition region corresponds to a surface that is formed by the vertices of the fifth column and the vertices of the sixth column. Additionally, the second acquisition region corresponds to a surface that is formed by the vertices of the first column to the vertices of the fourth column. The additional shape corresponds to a surface that is formed by the surface of the fourth column and the surface of the fifth column.

In the above example, the “second acquisition region” is limited only in that it is a region that is adjacent to a region having a depth difference, and there are no limitations with respect to how far from the region having the depth difference the second acquisition region may extend. In the configuration of FIG. 24, in the case of viewing the subjects from the direction of the line of sight L of the virtual camera, it is natural that the texture of the subject 2 is visible. That is, it is desirable that the texture of the subject 2 be assigned to the additional shape that is composed of the fourth column and the fifth column.

In the embodiment of FIG. 25A, corrections are performed at the third, fourth, and fifth columns in the texture coordinate system. In a case in which the second acquisition region is set such that a color difference in texture or a discontinuous depth difference is present, and correction is performed such that the texture within the second acquisition region is assigned to the additional shape, there is a possibility that the texture of the subject 3, rather than the texture of the subject 2, will be assigned to the additional shape. In a case in which the texture of the subject 3, which is a different subject, is assigned to a boundary between the subject 1 and the subject 2, there is a possibility that a sense of unnaturalness may be caused when viewing the image.

In the present modified example in FIG. 25B, a case is shown in which the second acquisition region is set such that a color difference in the texture is small and no discontinuous depth difference is present. Specifically, the second acquisition region corresponds to a surface that is formed by the vertices of the third and fourth columns. By setting the second acquisition region in this manner, it becomes possible to assign the texture of the subject 2 to the additional shape that is positioned at the boundary between the subject 1 and the subject 2. As a result, it becomes possible to suppress a sense of unnaturalness when viewing the image.

In order to set the second acquisition region such that the texture color difference is small and no discontinuous depth difference exists, it is necessary to perform a process for evaluating the texture color difference and the depth difference in a region that neighbors the region having a depth difference. The second acquisition region may be determined by evaluating one of a color difference in the texture, and a depth difference, and may also be determined such that both the color difference and the depth difference are equal to or less than a threshold.

An example of a texture color difference evaluation process that is executed by the association processing unit 104b will be explained below. First, an adjacent region and a neighboring region with respect to a region having a depth difference are defined. The adjacent region can be defined, for example, as a region within a predetermined number of pixels (for example, 10 pixels or less) from a distance edge. The distance edge is a region in the distance map in which a distance difference exceeds a threshold. Additionally, the neighboring region can be defined, for example, as a region that is located within a predetermined number of pixels (for example, several tens of pixels) from the distance edge, and that is not included in the adjacent region. Next, a process of evaluating an average color of the texture within the adjacent region is performed. Then, by evaluating a color difference between an average color of the texture within the adjacent region and a texture within a neighboring region, a region in which the color difference is equal to or less than a threshold can be determined as the second acquisition region. In this context, the color space and the color difference formula may be arbitrary, and examples include the CIELab color space and the CIE 1976 color difference formula.

Additionally, an example of a depth difference evaluation process that is executed by the association processing unit 104b will be explained below. First, a neighboring region of a region having a depth difference is defined. The neighboring region can be defined, for example, as a region within a predetermined number of pixels (for example, several tens of pixels) from a distance edge. Next, Euclidean distances to adjacent vertices are calculated for a group of vertices within the neighboring region, and a region in which the distance values are equal to or less than a threshold can be determined as the second acquisition region.

According to the present embodiment, it is possible to further reduce the computational cost while suppressing a sense of unnaturalness when viewing three-dimensional data that includes an occlusion.

### Other Embodiments

Although embodiments of the present disclosure have been explained above with reference to examples and drawings, the present disclosure is not limited to these embodiments, and various modifications and alterations may be made without departing from the gist of the present disclosure.

Additionally, some or all of the control in the above-described embodiments may be provided via a network or various storage media to a system or an apparatus in the form of a computer program that realizes the functions of the above-described embodiments. Then, a computer (or a CPU, an MPU, and the like) in the system or apparatus may read out and execute the program. In such a case, the program and the storage medium storing the program configure the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

The present disclosure can also be realized by supplying a program that realizes one or more functions of the above-described embodiments to a system or an apparatus via a network or a storage medium, and by having one or more processors of a computer in the system or the apparatus read and execute the program. Additionally, the present disclosure may also be realized by a circuit (for example, an ASIC) that realizes one or more functions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide an image processing technique that enables further reduction of computational cost while suppressing a sense of unnaturalness when viewing three-dimensional data that includes an occlusion.

This application claims the benefit of Japanese Patent Application No. 2024-179779, filed Oct. 15, 2024, which is incorporated herein in its entirety.

What is claimed is:

1. An image processing apparatus comprising:
at least one memory storing instructions; and
at lease one processor executing the stored instructions causing the image processing apparatus to:
acquire three-dimensional data including shape information and texture information;
generate an additional shape to be added to a shape corresponding to the acquired shape information; and
associate the shape information with the texture information,
wherein a resolution of vertices configuring the shape information is lower than a resolution of the texture information, and
wherein executing the stored instructions by the processor further causes the image processing apparatus to associate the acquired texture information with the additional shape.

2. The image processing apparatus according to claim 1,
wherein the three-dimensional data include information for vertices, and information for a surface formed by connection relationships between the vertices, and
wherein executing the stored instructions by the processor further causes the image processing apparatus to determine a region in which the additional shape is generated by using imaging information acquired from an imaging apparatus.

3. The image processing apparatus according to claim 2, wherein, when a region in which the additional shape is generated is a vicinity of a region having a depth difference in a shape of a surface of a subject as viewed from the imaging apparatus, and from among regions that are included in the three-dimensional data, a region on a front side using the imaging apparatus as a reference is made a first acquisition region and a region on a rear side using the imaging apparatus as a reference is made a second acquisition region, executing the stored instructions by the processor further causes the image processing apparatus to perform processing of assigning texture information of the second acquisition region to a region adjacent to the region having the depth difference.

4. The image processing apparatus according to claim 3, wherein executing the stored instructions by the processor further causes the image processing apparatus to perform correction to change texture coordinate values associated with the surface and set texture coordinates for a region of the additional shape.

5. The image processing apparatus according to claim 4, wherein executing the stored instructions by the processor further causes the image processing apparatus to set vertices that are correction targets of the texture coordinates, and update texture coordinate values by setting a correction amount and a correction direction of texture coordinate values and thereby correcting texture coordinate values for each of the vertices that are the correction targets.

6. The image processing apparatus according to claim 3, wherein executing the stored instructions by the processor further causes the image processing apparatus to generate, as the additional shape, a surface connecting a surface in the first acquisition region and a surface in the second acquisition region.

7. The image processing apparatus according to claim 3, wherein executing the stored instructions by the processor further causes the image processing apparatus to generate, as the additional shape, a surface that is continuous with a surface in the second acquisition region and that is not continuous with a surface in the first acquisition region.

8. The image processing apparatus according to claim 3, wherein executing the stored instructions by the processor further causes the image processing apparatus to assign texture information corresponding to a specific reference region in a texture coordinate system to the additional shape.

9. The image processing apparatus according to claim 8, wherein executing the stored instructions by the processor further causes the image processing apparatus to set the reference region that is calculated from a statistical value of pixel values in a background-side region of the subject.

10. The image processing apparatus according to claim 3,
wherein executing the stored instructions by the processor causes the image processing apparatus to correct pixel values in a minute region in a texture coordinate system, and assign texture information corrected by the correction unit to the additional shape.

11. The image processing apparatus according to claim 10, wherein executing the stored instructions by the processor further causes the image processing apparatus to set, as a correction target region, a minute region that is not assigned to the first acquisition region and the second acquisition region.

12. The image processing apparatus according to claim 1,
wherein the three-dimensional data includes data of a plurality of polygons formed by connecting a plurality of vertices, and
wherein executing the stored instructions by the processor further causes the image processing apparatus to assign texture information such that a statistical value of an area of a reference region in a texture coordinate system referenced by each polygon in an additional shape is smaller than a statistical value of an area of a reference region in a texture coordinate system referenced by each polygon other than the polygons in the additional shape.

13. The image processing apparatus according to claim 5, wherein executing the stored instructions by the processor further causes the image processing apparatus to change the correction amount according to the depth difference.

14. The image processing apparatus according to claim 5, wherein executing the stored instructions by the processor further causes the image processing apparatus to set a correction amount to be equal to or greater than an amount of misalignment between a shape and a texture in the region having the depth difference.

15. The image processing apparatus according to claim 5, wherein executing the stored instructions by the processor further causes the image processing apparatus to set the correction amount based on defocus information of an imaging optical system.

16. The image processing apparatus according to claim 5,
wherein the three-dimensional data includes data of a plurality of polygons formed by connecting a plurality of vertices, and
wherein executing the stored instructions by the processor further causes the image processing apparatus to perform shape modification to reduce an area of a polygon in the first acquisition region by modifying vertex coordinates.

17. The image processing apparatus according to claim 16, wherein executing the stored instructions by the processor further causes the image processing apparatus to add a vertex into the first acquisition region during the shape modification.

18. The image processing apparatus according to claim 3, wherein executing the stored instructions by the processor further causes the image processing apparatus to determine the second acquisition region by evaluating at least one of a color difference and continuity of shape.

19. An image processing method executed by an image processing apparatus that performs image processing on three-dimensional data including shape information and texture information, the method comprising:
acquiring the three-dimensional data;
generating an additional shape to be added to a shape corresponding to the acquired shape information;
associating the shape information with the texture information,
wherein a resolution of vertices configuring the shape information is lower than a resolution of the texture information, and
wherein during the association, the acquired texture information is associated with the additional shape.

20. A non-transitory storage medium storing a program of an image processing apparatus that performs image processing on three-dimensional data including shape information and texture information causing a computer to perform each step of the image processing method according to claim 19.
